(19) United States
(12) Patent Application Publication
(10) Pub. No.: US 2007/0203979 A1
(43) Pub. Date: Aug. 30, 2007

(54) Home communications server

(76) Inventors: Mark R. Walker, Beaverton, OR (US); Ylian Saint-Hilaire, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/354,524

(22) Filed: Feb. 14, 2006

(51) Int. Cl. G06F 15/16

(52) U.S. Cl. 709/204

(57) ABSTRACT

In some embodiments a request for an outside line for a telephony call is identified by a requesting extension device coupled to a home network, telephony calls via an Internet connection are placed on behalf of the requesting extension device, inbound calls from the Internet connection are detected, and the inbound calls are routed from the Internet connection to an appropriate extension device coupled to the home network. Other embodiments are described and claimed.

### RELATED APPLICATIONS

This application is related to U.S. patent application Ser. No. 10/292,609 filed on Nov. 12, 2002, entitled “Network Adapter for Remote Devices”, by James Edwards and Ylian Saint-Hilaire.

This application is also related to U.S. patent application Ser. No. “TO BE DETERMINED”, filed on Feb. 14, 2006, entitled “Digital Communications Adaptor”, by Mark R. Walker and James Edwards.

### TECHNICAL FIELD

The inventions generally relate to a home communications server.

### BACKGROUND

Voice-over-IP (Voice-over-Internet Protocol or VoIP) is a term used to describe voice communications over the Internet. Current VoIP users are generally in the early adopter category. That is, current VoIP users are a relatively small but rapidly growing group of consumers willing to tolerate an imperfect audio quality in exchange for features such as very low cost long distance voice access to any other Internet accessible VoIP phone in the world (and in some cases, any phone in the world). The evolution of VoIP from a computer hobbyist technology into a solution for mass market communications is predicted to accelerate as major telecommunications and cable providers enter the market and provide added capacity and improved quality. The recently developed 3^{rd} Generation Partnership Project (3GPP) IP Multimedia Subsystem (IMS) recommendations for Session Initiation Protocol-Session Description Protocol (SIP-SDP)-based call control have now established a required foundation for interoperability between IP communications providers. Further, a number of Internet Engineering Task Force (IETF) signaling and network protocol standard recommendations that specify the operation of VoIP devices have been undergoing a process of consolidation and profiling within the industry, thus increasing greatly assurances of phone-to-provider interoperability.

The exponential growth rate of VoIP subscribers worldwide, increasing deployment of broadband Internet access to the home, and the steady increase in the number of installed home networks creates an opportunity to support new communication experiences in the digital home. Users will soon have access to new IP-based devices, services, and capabilities that go far beyond what today's communications technologies can deliver.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a home communications server according to some embodiments of the inventions.

FIG. 3 illustrates a system according to some embodiments of the inventions.

FIG. 4 illustrates a system according to some embodiments of the inventions.

FIG. 5 illustrates a system according to some embodiments of the inventions.

FIG. 6 illustrates a system according to some embodiments of the inventions.

### DETAILED DESCRIPTION

Some embodiments of the inventions relate to a digital home communications network.

Some embodiments of the inventions relate to a home communications server.

Some embodiments of the inventions relate to a digital communications adapter.

In some embodiments a request for an outside line for a telephony call is identified by a requesting extension device coupled to a home network, telephony calls via an Internet connection are placed on behalf of the requesting extension device, inbound calls from the Internet connection are detected, and the inbound calls are routed from the Internet connection to an appropriate extension device coupled to the home network.

In some embodiments a home communications server includes a Universal Plug and Play interface is to identify a request for an outside line for a telephony call by a requesting extension device coupled to a home network, and an IP telephony signaling and control module is to detect inbound calls from an Internet connection and to route the inbound calls to an appropriate extension device coupled to the home network, and to place calls via the Internet connection on behalf of the requesting extension devices coupled to the home network.

In some embodiments an article includes a computer readable medium having instructions thereon which when executed cause a computer to identify a request for an outside line for a telephony call by a requesting extension device coupled to a home network, place telephony calls via an Internet connection on behalf of the requesting extension device, detect inbound calls from the Internet connection, and route the inbound calls from the Internet connection to an appropriate extension device coupled to the home network.

In some embodiments audio and video data is transmitted from audio/video devices to a home network, and audio and video data is received from the home network to display on audio/video devices to enhance a two-way videoconference, and an interface is provided to the home network to provide control of the video and audio communications between the home network and one or more external audio/video devices.

In some embodiments a digital communications adaptor includes an audio/visual stream control module to transmit and receive audio and video to and from a home network, and a Universal Plug and Play control module to interface with the home network to provide control of video and audio communications between the home network and one or more external audio/video devices.

In some embodiments an article includes a computer readable medium having instructions thereon which when executed cause a computer to transmit audio and video data from audio/video devices to a home network, receive audio and video data from the home network to display on audio/video devices to enhance a two-way videoconference, and interface with the home network to provide control of the video and audio communications between the home network and one or more external audio/video devices.

New communications experiences will require a digital home communication architecture including new classes of communications devices. Increasing consumer communication needs may be met by a new framework for digital home communications and development of new digital communications device classes. In some embodiments a digital Home Communications Server (HCS) and a Digital Communications Adapter (DCA) may be implemented. In some embodiments the HCS is similar in function to enterprise digital private branch exchange (PBX) systems, but is tailored specifically for home use and provides services on a home network via UPnP (Universal Plug and Play) technology. An HCS is able to meet consumer needs by providing a single entity for managing all home IP (Internet Protocol) communications in a manner that abstracts the differences between different forms of communications such as voice, email, instant messaging, etc. The HCS empowers consumers with a high degree of control over family communications by enabling complete personalization of HCS behavior through available UPnP interfaces. In some embodiments the DCA is used to adapt legacy consumer electronics (CE) equipment such as a television set (TV) for use as a communications device on a home network. The DCA can be used to capture and render voice, video, pictures, audio, and/or text, for example, for richer communications. The HCS and DCA devices can use existing UPnP technologies for digital home communications, for example in a manner similar to that established by DLNA (Digital Living Network Alliance) for networked digital home entertainment.

It appears that IP-based communications will gradually replace Public Switched Telephone Network (PSTN) communications over time due to lower overall costs to the consumer and the ability to support richer communications such as video, instant messaging, and picture sharing, for example.

Communication is increasingly taking place within a ‘virtual home’ environment. ‘Virtual home’ is intended to highlight the fact that many people are spending as much time outside their primary residence communicating and coordinating as they do inside that residence. For example, families are spending time at children's sports events and practices, churches, gyms, in automobiles, etc. Two key forces that drive the need for communication are ‘staying in touch’ and ‘planning’. Many family member are staying in touch using a variety of communication devices to achieve a feeling of togetherness. Planning is the organization of family daily routines and dealing with the logistics of those routines. Families are spending more and more time planning their day and communicating those plans to family members. Consumers are using an increasingly diverse and non-interoperable set of communication channels such as cell phones, pagers, email, Instant Messages (IM), and landline phones. The diversity of these channels has created ‘islands’ of multiple inboxes for messages, contact lists, calendars, etc, causing extra time spent on bridging information and content between the various channels. Consumers want to easily juggle diverse communications channels while minimizing the amount of personal attention required to distinguish between wanted communication (for example, from friends and family) and unwanted communication (for example, from telemarketers), and be able to easily block such unwanted communication. Further, consumers want to have appropriate contact information to be easily available, including the preferred communication means of the person being contacted. Additionally, consumers have a desire to use technology to maximize a sense of togetherness when friends or family members are apart.

Although the traditional concept of home is being supplanted by the ‘virtual home’, the physical home can provide a base for deploying technology solutions that combine personal communication devices in a manner that affords users a feeling of home while they are away. Although ‘away from home’ technology solutions such as cell phones are not likely to be completely replaced with home-based technology solutions, the ‘away from home’ solution such as a cell phone may use emerging VoIP standards to integrate with in-home solutions to help enhance the virtual home user experience. A user-transparent, home framework for connecting diverse groups of communication devices and for sharing information can help bridge disparate communication channels. A centralized entity (or at least a user perception of a centralized entity) can manage all forms of family communications such as calls, messages, alerts, calendars, etc. Proven networking technologies such as, for example, Ethernet, 802.11, IPv4, HTTP, UPnP, etc. can allow for maximum availability and/or access to the framework and address a desire for control and management. Access to and use of the framework from outside the home supports the virtual home environment. Full user personalization and control of wanted and unwanted contacts, personalized policies for call and message handling, etc. helps address the consumer desire for communication protection. Using the framework to abstract calls, IMs, etc. allows personalization of control to be universally applied regardless of the communication type. Richer communications experiences such as video conferencing, sharing pictures while talking, etc. help address the need to achieve a greater sense of closeness.

The DLNA framework for network-connected entertainment devices may be used as a model to develop a home digital communications framework. A Home Communications Server (HCS) can be similar in essential function to an enterprise PBX, but tailored specifically to home use models. Digital Communications Adapters (DCA) can be client devices that depend on the HCS through a home network. For example, a DCA can allow a legacy television set to be used for richer communications such as video conferencing. Other categories of client devices that can interact with and derive value from the HCS but are not necessarily dependent on the HCS include cell phones, VoIP wireless handsets, etc.

In some embodiments HCS implementations support a high ease of use by allowing a newly purchased or ‘guest’ communications device to transparently register and use the home VoIP service provider for both inbound and outbound calls, for example. This HCS connection process can be as similar as possible to current methods for connecting VoIP clients to a service provider. Outbound calls can be placed as requests to the HCS.

The HCS can allow a net-connected device to browse listings of contacts. Contact entries can be in a form to allow communications-capable clients to transparently make outbound calls using a channel preference of the person being contacted. HCS implementations can also support easy editing/updating of contact listings by authorized client devices and/or applications.

An HCS can also allow authorized applications and/or client devices to set incoming call policies for call routing, call blocking/blacklisting, call forwarding to voicemail, client ring order, client ring tone, and external call forwarding, for example, all based on who is calling and/or other criteria (for example, time/date information). An HCS can also allow similar or the same policies to be set for incoming IMs and emails, for example, to eliminate differences between calls and messages in the task of setting home policies.

An HCS can also enable compelling new user experiences by allowing authorized client devices and/or applications to actively monitor all extensions and who they are connected to, and to be able to set up conference calls on the fly. HCS implementations can also be integrated with other productivity and planning applications (for example, the calendar).

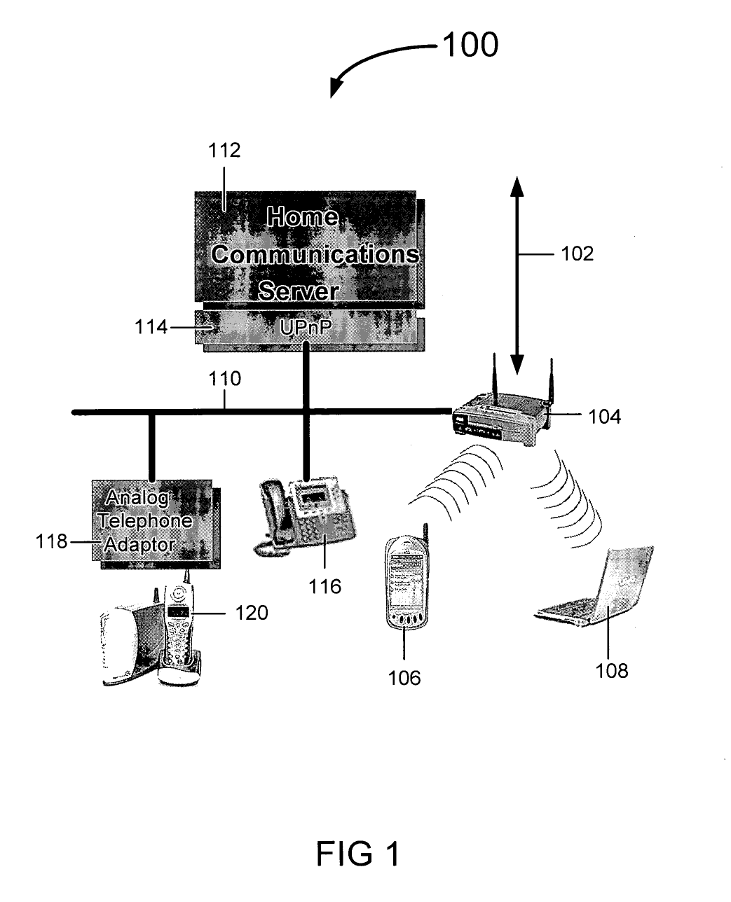

FIG. 1 illustrates a digital home communications system 100 according to some embodiments. In some embodiments system 100 includes an Internet connection 102, a router 104, wireless devices such as a PDA 106 and a laptop computer 108, a home network 110 (for example a Local Area Network or LAN), a Home Communications Server (HCS) 112 using Universal Plug and Play (UPnP) interface technology 114, a digital telephone 116, an analog telephone adapter 118, and an analog telephone 120.

In some embodiments the HCS 112 is connected to the Internet 102 through the home network 110 and the router 104. The HCS may be bound to a specific VoIP service provider. The HCS may also employ Session Initiation Protocol (SIP) telephony and signaling for connections to the service provider and for receiving/acknowledging incoming calls.

On the network the HCS 112 can expose UPnp technology service interfaces 114 to other networked devices that have UPnP control points. IP communication devices utilize their control points using UPnP technology to discover the HCS 112 and obtain IP addresses of the device and its service interfaces.

In some embodiments HCS 112 can provide service in four functional categories, including basic communications services, extended communications services, remote access, and communication notices/alerts, for example.

In some embodiments HCS 112 provides basic communication services. After obtaining HCS IP addresses, IP communication client devices register with the HCS. Registered client information includes current IP address, friendly device identification, and audio capability profile. Audio capabilities can be enumerated in the form of SDP parameter lists that include the audio codecs supported by the device, ordered according to device preference. Once registered, IP communication client devices can utilize SIP proxy functionality of the HCS to place outbound calls. SIP client devices literally call the HCS, which then forwards the call to the service provider. Calls inbound to the HCS from the service provider are routed to registered client IP addresses per call routing procedures.

In some embodiments HCS 112 provides extended communications services. Extended communications services allow the HCS to be managed and configured by any authorized client device. Extended communications services management functions include, for example, browse/search/edit/update, manage message archives, and manage home communication policies. Browse/search/edit/update functions allow any device to view and edit XML-standard form contact listings. Contact metadata contains detailed technical information that enables, among other attributes, user selection of the right ‘channel’ when a user initiates an outbound call. Communication clients may first browse for a specific contact and include the contact listing reference in the outbound call request. Listings can also include recently dialed/received contacts. In some embodiments HCS users manage contact listings using XML as the exchange format. The activity may be made even more user-friendly by supporting ‘1-button’ contact list synchronization. That is, a communications device with a native contact list can instantly synchronize with the HCS on its personalized contact subset. Manage message archives functions allow consumers to manage combined views of HCS voice, text message, and email listings, as well as forward, delete, and save messages, for example. Manage home communication policies functions allow users to manage XML HCS policies. For example, these XML HCS policies can include routing of all incoming calls/messages/mails based on caller/sender ID to specific client extensions based on the device ID, blocking calls/messages/mails based on time of day and caller/sender ID, call/message/mail prioritization by prioritizing call/sender ID-based priorities for incoming communications and device ID-based priorities for outbound calls, caller/sender ID forwarding of call/message/mail to voicemail, caller/sender ID-based client extension ring/alert tone, and/or caller/sender ID-based external call/message/mail forwarding.

In some embodiments HCS 112 provides remote access. Family members can log into the HCS 112 and register their current IP addresses when they are outside the home. The HCS 112 can then forward inbound calls, messages, and mail to externally-located users based on its forwarding policies. Using current standards for Internet security, users are additionally able to use HCS extended communication services including the management functions described above.

In some embodiments HCS 112 provides communication notices/alerts. In some embodiments the HCS 112 includes functionality for discovering digital media rendering services (for example, DTVs or digital TVs, digital stereos, etc.) connected to the home network 110 for the purpose of forwarding notifications of incoming calls and other alerts.

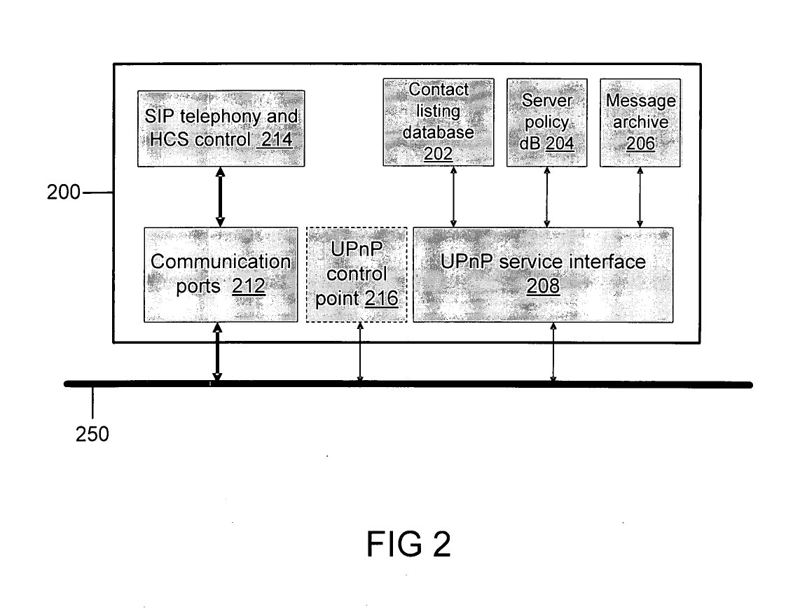

FIG. 2 illustrates a Home Communications Server (HCS) 200 according to some embodiments. HCS 200 is coupled to a home network 250 (for example, a LAN). HCS 200 includes a contact listing database 202, a server policy database 204, a message archive 206, a UPnP service interface 208, communication ports 212, SIP telephony and HCS control 214, and/or UPnP control point 216. In some embodiments the contact listing database 202, the server policy database 204, and the message archive 206 are exposed directly through the UPnP service interface 208, which is coupled to the home network 250. In some embodiments the UPnP service interface 208 also exposes the communication ports 212 available for outbound calls. The SIP telephony and HCS control module 214 receives inbound calls, messages, etc., and routes them to registered client devices according to policy. In some embodiments UPnP control point 216 is included to discover and utilize other UPnP devices, including in some embodiments, display devices.

In some embodiments, an HCS provides a single entity for managing all home IP communications in a manner that abstracts the differences between various forms of communication such as voice, email, IM, etc. The HCS empowers consumers with a high degree of control over family communications by enabling complete customization of HCS behavior through UPnP interfaces, for example.

According to some embodiments home IP communications users can also realize call quality assurances and voice interaction via an HCS. Using the HCS as a proxy mechanism for initiating outbound calls allows the HCS to accept/reject call requests based on detected available bandwidth (for example, on both a LAN and a LAN/WAN boundary). A user receiving an acknowledgement from the HCS for the requested call is generally assured of the bandwidth necessary to maintain a good communications experience. This will become an especially critical capability as network-connected digital entertainment devices are deployed and begin consuming bandwidth on home networks. HCS implementations may also include capabilities such as voice recognition and Text-To-Speech (TTS). Voice recognition can be utilized to establish voice user interface for command and control functions such as voice dialing and voice browsing/searching of contacts. TTS capabilities can be employed for talking IMs and emails.

In some embodiments a personal computer (PC) is used as an HCS device. A PC possesses both advantages and challenges for implementing HCS functionality. Some of the major advantages of using a PC for HCS functionality include computational power for rendering rich user interfaces (UIs) used for communications management, storage capacity for storing messaging and contact info, and the ability to provide voice recognition and TTS applications. Challenges include a perceived gap in the level of robustness that consumers associate with CD appliances. Therefore, an HCS implementation might be perceived as a single point of failure in case of power outage, denial-of-service (DOS) attacks, or software or hardware failure, and consumers accustomed to the reliability of traditional PSTN telephones might have concerns. Therefore, in some embodiments HCS functionality may be split across two platforms connected to a home network. In some embodiments basic communication functions can be deployed on a CE appliance device possessing an uninterrupted power supply or batter backup, for example, and remaining extended capabilities such as HCS management can be supported by a PC. In this manner a PC can greatly enhance the convenience, manageability, and personalization of home IP communications, and can bridge to IP-connected entertainment devices without being in the critical path.

The presence of both communication and digital entertainment devices connected to a home network provides an opportunity for supporting communication experiences that take advantage of the rich media features of entertainment devices. For example, high-definition televisions have the potential to delivery individual video conferencing, full family video conferencing, picture and music-sharing communication in the family room in a manner more compelling than previous generations of video telephony devices. For example, according to some embodiments, family members unable to be together for the holidays can establish a high-definition video conferencing session between household members in the family room. Such sessions can be enhanced by the ability to spontaneously share photos and music, for example. According to some embodiments a persistent communication channel (or channels) can be enabled, for example, to monitor elderly or infirmed individuals. Direct support for control of persistent video conferencing from the remote control of a digital television (DTV) can effectively provide closeness with friends and family members in the form of ‘channels’, controlled and selected in the same say that cable entertainment is controlled and selected.

According to some embodiments a Digital Communications Adapter (DCA) is used for personal videoconferencing, for example. A DCA is architecturally similar to Digital Media Adapters (DMAs) in that they rely on a connection to a home media server and they function principally to render digital streams onto legacy television sets, for example. However, DCAs add two-way audio and/or two-way video capture and media sharing capabilities to the basic DMA profile. According to some embodiments the DCA depends on the HCS to respond and to connect it to incoming calls. All external telephony, links to service provider, contact listings, etc. are the responsibility of the HCS. A DCA is a low cost device for a personal videoconference implementation. The DCA is able to achieve a low cost by off-loading functionality to the server (HCS). Functionality that can be off-loaded to the HCS include contact archives, SIP telephony, certificates needed for authentication to a service provider, etc. Such functionality would otherwise be required to be implemented by the device locally. Low manufacturing costs allow consumers to deploy videoconferencing on every television in the home. Since a DCA can be connected to TVs through an auxiliary or similar type of connector, the DCA and the video conferencing experience can be selected from the TV remote just like any other channel.

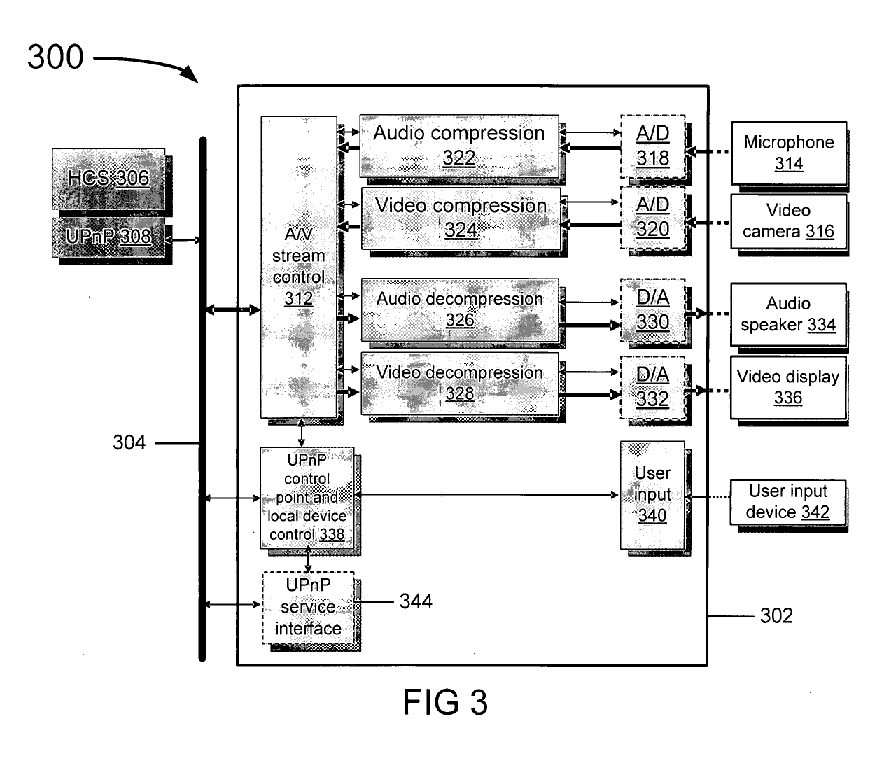

FIG. 3 illustrates a system 300 according to some embodiments. System 300 includes a Digital Communications Adapter (DCA) 302, a home network 304, and a Home Communications Server (HCS) 306. HCS 306 is coupled to home network 304 (for example, a LAN) via a UPnP service interface 308. DCA 302 includes an audio/visual (A/N) stream control module 312, an analog to digital (A/D) conversion module 318, an A/D conversion module 320, an audio compression module 322, a video compression module 324, an audio decompression module 326, a video decompression module 328, a digital to analog (D/A) conversion module 330, a D/A conversion module 332, a UPnP control point and local device control module 338, user input module 340, and UPnP service interface 344.

The A/V stream control module 312 simultaneously manages the flow of received and transmitted packets of audio and video. An external microphone 314 and an external video camera 316 captures audio and video. If the microphone 314 and video 316 sensors are analog devices, the A/D conversion modules 318 and 320 are needed to generate digitized audio and video samples, respectively. If the audio speaker 334 and the video display 336 are analog devices, the D/A conversion modules 330 and 332 are respectively needed to generate analog signals to those devices 334 and 336. The thick black lines between A/V stream control module 312, microphone 314, video camera 316, A/D conversion module 318, A/D conversion module 320, audio compression module 322, video compression module 324, audio decompression module 326, video decompression module 328, D/A conversion module 330, D/A conversion module 332, audio speaker 334, and video display 336 represent the flow of audio and video media. The thin black lines between the devices in FIG. 3 represent the flow of control information.

The UPnP control point and local device control module 338 allows the DCA 302 to discover and utilize the HCS 306 and manage commands received from the DCA user input device 342 via the user input module 340. DCA 302 may optionally host its own UPnP service interface 334 to enable the DCA 302 to be utilized by other UPnP devices connected to the network 304. The DCA 302 UPnP services may allow the DCA to be notified of and receive inbound calls from other communication devices within the home via the network 304.

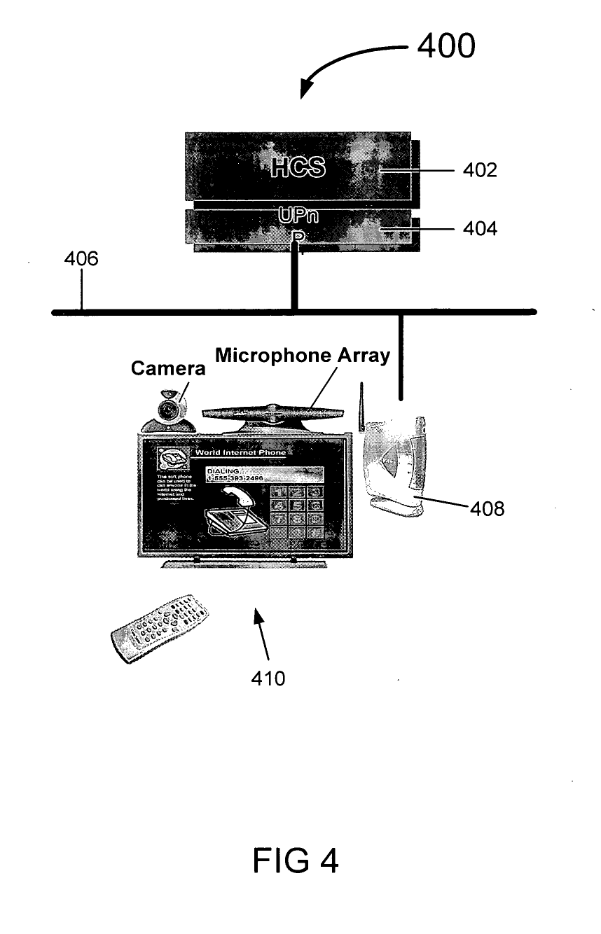

FIG. 4 illustrates a system 400 according to some embodiments. System 400 includes an HCS 402 having a UPnP service interface 404, a home network 406 (for example, a LAN), a DCA 408, and a home entertainment device 410. When an HCS is located (for example, HCS 402) the DCA 408 utilizes browse contacts capability to identify contacts with videoconferencing capability. Contact metadata include sufficient information to establish media format and transport protocol compatibility between a caller and a callee in a manner transparent to the user.

Although home entertainment device 410 in FIG. 4 appears as a television set with a remote control, a microphone array, and a camera, it is noted that home entertainment device 410 can be any type of entertainment device according to some embodiments.

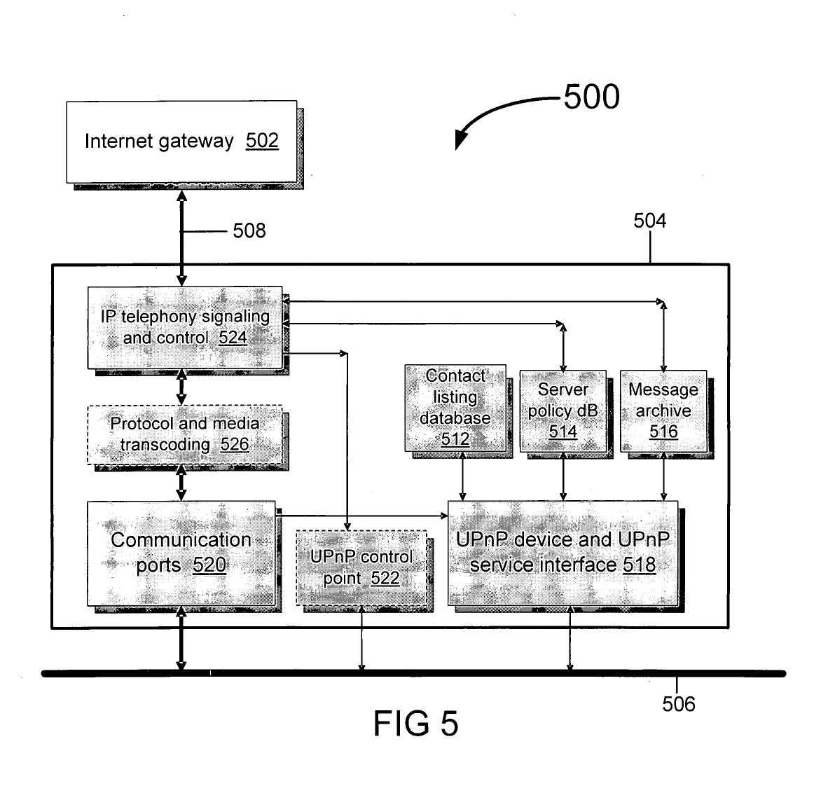

FIG. 5 illustrates a system 500 according to some embodiments. System 500 includes an Internet gateway 502 provided, for example, by an Internet Protocol (IP) Communications Service Provider, a digital Home Communications Server (HCS) 504, and a home network 506 (for example, a LAN). Internet gateway 502 provides an Internet connection to HCS 504. HCS 504 includes a contact listing database module 512, a server policy database 514, a message archive module 516, a Universal Plug and Play (UPnP) device and UPnP service interface module 518, a communications port module 520, a UPnP control point module 522, an IP telephony signaling and control module 524, and a protocol and media transcoding module 526. The HCS 504 is coupled to the home network 506 and is also connected to the Internet via the Internet gateway 502. The heavy black lines in FIG. 5 between Internet gateway 502, IP telephony signaling and control module 524, protocol and media transcoding module 526, communication ports module 520, and home network 506 indicate the flow of actual communications and media. The light black lines between IP telephony signaling and control module 524, contact listing database module 512, server policy database module 514, message archive module 516, UPnP device and UPnP service interface module 518, UPnP control point module 522, and home network 506 indicate the flow of information.

The HCS 504 is a server for home IP telephony (for example, Voice Over IP or VoIP) and can be used to accomplish one or more of several related IP telephony functions. For example, in some embodiments HCS 504 can route all incoming VoIP calls and instant messages (IMs) to designated extensions connected to the home network 506 (for example, VoIP phones connected to the home network 506) according to policies set by the user and based on caller ID, day, and/or time of day, etc. In some embodiments HCS 504 makes use of an archive (for example, message archive module 516) for quick access to standard-form XML contacts listings with a UPnP standard service interface module (for example, UPnP device and UPnP service interface module 518). In some embodiments HCS 504 makes a proxy of all calls made by devices connected to the home network (for example, made by LAN-connected devices) to the external IP communications service provider via the Internet gateway 502. In this manner all home network connected devices (for example, all LAN-connected devices) may be agnostic of the service provider.

Contact listing database module 512 is a database for listings of personal contacts. Contact listings are composed of user-friendly information like names and addresses, as well as ‘machine’ metadata required to establish a session over the Internet. According to some embodiments XML may be employed to create a standard form for serializing of contact listing metadata from the database. Server policy database module 514 is the database for holding policies for routing calls to extensions based on, for example, caller ID, etc. According to some embodiments XML may be employed to create a standard form for serializing of HCS policy metadata from the database. Message archive module 516 is an archive for voice and text messages.

The HCS 504 exposes the UPnP device and UPnP service interface module 518 (for example, a UPnP standard service interface) to other devices. The provided services include basic communication services and extended communications services. Basic communication services enable network connected extension devices (for example, LAN-connected extension devices) to receive inbound calls and to place outbound calls. Following UPnP standard procedures to discover the HCS 504 and acquire the IP address of the HCS service interface 518, extension devices register with the HCS 504 to receive incoming calls by utilizing a UPnP action to forward information to the HCS 504 including, for example, current IP address, friendly device identification, and/or audio capability profile. In some embodiments extension devices utilize a UPnP action to request an outside line for a call. The UPnP action may include the information submitted by the extension identifying the external phone desired for connection. The HCS 504 returns to the extension an IP address and port number associated with communication ports module 520. The HCS 504 employs, for example, standard IP telephony and a finding to a specific IP communications service provider to place the call to the external phone on behalf of the requesting extension.

Extended communications services are UPnP actions that allow the HCS 504 to be managed and configured by any network-connected device (not just by those devices capable of communications). In some embodiments UPnP actions for HCS management include browse/search contact listings, access/manage message archives, and/or access/manage home communications policies. Browse/search contact listings allows any device to view contact listings stored in contact listing database module 512. Contact metadata contains detailed technical information that enables user selection of, among other attributes, the right ‘channel’ when a user initiates an outbound call. Devices capable of communication may first browse for a specific contact and include the contact listing reference in the outbound call request described above in reference to basic communications services. Listings can also include recently dialed/received call contacts. In some embodiments a separate UPnP action may also be included to update/edit contact listings. Access/manage message archives allows any device to access and manage the contents of message archive module 516. Both voice and instant text messages (IMs) may be combined for easy access and management. Access/manage home communications policies allows users to manage HCS policies for the home. Policies set through the UPnP interface module 518 are executed by the IP telephony signaling and control module 524. Possible managed policy items may include routing of all incoming calls/messages/mails based on caller/sender ID to specific client extensions based on device ID, blocking of calls/messages/mail blocking based on time of day and/or caller/sender ID, and/or forwarding of call/message/mail to message archive module 516 based on caller/sender ID.

Communications ports module 520 hosts the IP addresses and ports for all calls that take place on the network 506 (for example, LAN). The number of ports currently available may be the result of a dynamic calculation of the bandwidth available on the network 506 and on the external Internet connection 508 at a given point in time. Thus, for example, if ten ports are available, there is sufficient estimated bandwidth for ten simultaneous calls on the network 506 (for example, LAN).

UPnP control point module 522 is an optional UPnP control point. The UPnP control point module 522 receives notification of inbound calls from IP telephony signaling and control module 524 and forwards the call notifications to other UPnP devices (for example, Audio/Visual rendering and/or remote User Interface devices for display to a user).

IP telephony signaling and control module 524 performs IP telephony and signaling control using, for example, Session Initiation Protocol (SIP), a method for IP telephony. In some embodiments, module 524 further detects inbound calls to the HCS 504 and routes them to the appropriate extension after consulting routing policies set by the user and help in server policy database module 514, forwards voice and text messages to the message archive module 516 based on policies set by the user and help in server policy database module 514, and/or places calls via the service provider to external phones on behalf of requesting extensions connected to the network 506.

Protocol and media transcoding module 526 is an optional module that may be used to provide protocol and media transcoding on behalf of extension devices.

The HCS 504 enables a simple way for any IP phone to be quickly registered on the HCS. In some embodiments, employing standard UPnP protocols for discovery of the HCS 504 and its service interface allows the process of connecting any phone extension to the home communications network 506 to be automated in a manner that is completely transparent to the user.

In some embodiments, since outbound and inbound calls are proxied to the IP communications service provider by the HCS 504 on behalf of all phone extensions connected to the network 506 (for example, a LAN), all extensions may be agnostic of the service provider. The consumer may thus be able to pay only one fee for the HCS access and fees for individual phone extensions may not be required.

By using optional UPnP control point module 522 the HCS 504 can utilize any existing UPnP A/V or remote UI device. Higher-level software implementations can utilize this feature to merge communications and entertainment (for example, Caller ID notifications and HCS management UIs utilized on a television set).

In some embodiments a personal computer (PC) may be used for HCS implementations. The HCS needs reliability and is a good candidate for partition technology. Deploying an HCS on a PC presents an opportunity to create new uses that combine communications with entertainment applications (for example, Intel Viiv technology entertainment applications). According to some embodiments the use of UPnP standards for discovery and service access allows all IP communications device manufacturers to automate connection to the home network without requiring active engagement by the user.

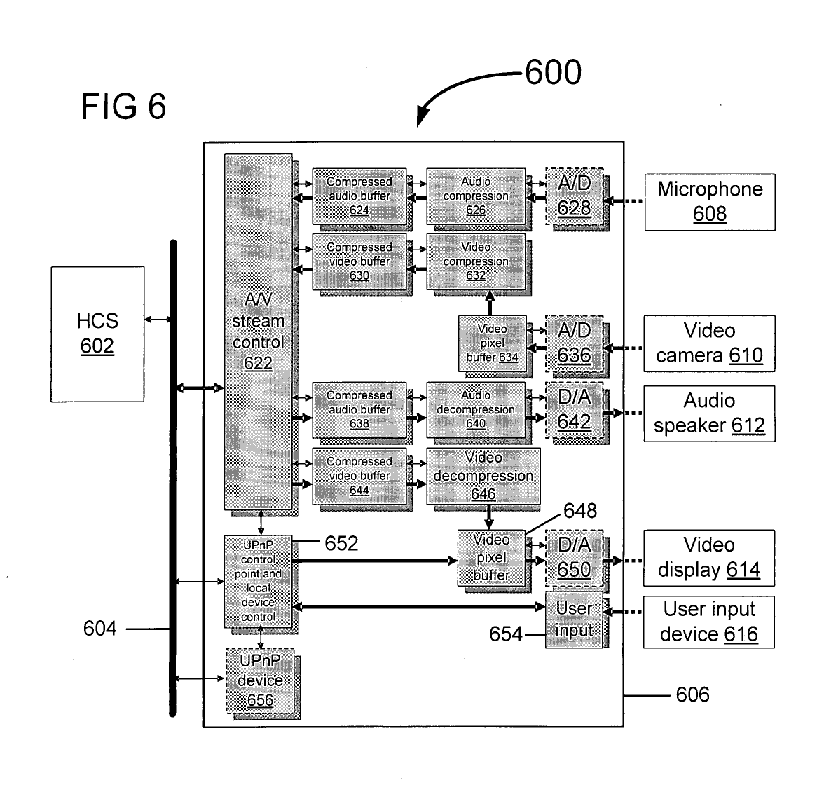

FIG. 6 illustrates a system 600 according to some embodiments. System 600 includes a Home Communications Server (HCS) 602, a home network 604 (for example, a LAN), a Digital Communications Adapter (DCA) 606, a microphone 608, a video camera 610, an audio speaker 612, a video display 614, and a user input device 616. DCA 606 includes an Audio/Visual (A/V) stream control module 622, a compressed audio buffer 624, an audio compression module 626, an analog to digital (A/D) module 628, a compressed video buffer 630, a video compression module 632, a video pixel buffer 634, an A/D module 636, a compressed audio buffer 638, an audio decompression module 640, a digital to analog (D/A) module 642, a compressed video buffer 644, a video decompression module 646, a video pixel buffer 648, a D/A module 650, a UPnP control point and local device control module 652, a user input module 654, and a UPnP device 656.

In some embodiment DCA 606 exploits the base media rendering and remote network control function of a Digital Media Adapter (DMA) while further adding two-way communications capabilities. This enables an inexpensive solution for two-way audio/video communications (for example, on a legacy television set).

An example of a DMA device is provided in U.S. patent application Ser. No. 10/292,609 filed on Nov. 12, 2002, entitled “Network Adapter for Remote Devices”, by James Edwards and Ylian Saint-Hilaire. A DMA is a content rendering device that converts a stream of digital media conveyed over a home network (for example, a LAN) into an analog signal. The DMA analog output signal may be connected to analog inputs, for example, on a television set (for AV output) and/or a stereo (for audio output). The operation of a DMA is dependent on a digital media server (DMS) that is also connected to the home network (for example, provided via IEEE 802.3 and/or IEEE 802.11 technology). The DMS can include a UPnP service interface with functions for content browsing, rendering setup, etc. that allow the DMA to be a relatively inexpensive and low-resource device.

According to some embodiments a DCA is implemented that has some similarities with a DMA device. According to some embodiments a DCA is a low resource appliance and is dependent on a digital Home Communications Server (HCS) that has some similarities with a DMS and is accessible over a home network. According to some embodiments the HCS includes a UPnP service interface with functions for browsing/searching through personal contact lists, enabling call setup, etc. These HCS capabilities are needed to enhance DCA functions. Using these HCS capabilities on the HCS over the network (for example, LAN) rather than implementing them natively in the DCA allows DCA devices to be relatively inexpensive and low-resource appliances.

A/D modules 628 and 636 and D/A modules 642 and 650 of DCA 606 are optional modules for A/D conversion and D/A conversion, respectively. These modules are needed when the corresponding externally connected I/O device (for example, microphone 608 for A/D conversion module 628) is an analog device. In some embodiments, external I/O devices such as microphones and cameras, for example, can perform A/D conversion and provide digitized signals for input to the DCA 606.

The thick lines in FIG. 6 (for example, some of the lines between microphone 608, A/D conversion module 628, audio compression module 626, compressed audio buffer 624, A/V stream control module 622, compressed video buffer 630, video compression module 632, video pixel buffer 634, A/D conversion module 636, video camera 610, compressed audio buffer 638, audio decompression module 640, D/A conversion module 642, audio speaker 612, compressed video buffer 644, video decompression module 646, video pixel buffer 648, D/A conversion module 650, video display 614, UPnP control point and local device control module 652, user input module 654, and/or user input device 616) indicate the flow of audio and/or video media. Thin lines in FIG. 6 indicate the flow of control information.

External microphone 608 captures audio from the environment. If microphone 608 is analog then the A/D conversion module 628 is inserted in DCA 606 to generate, for example, pulse-code modulated (PCM) digital audio samples. The audio compression module 626 employs at least one digital audio compression algorithm to reduce the effective data rate of the stream of PCM samples. Audio compression module 626 may temporarily hold a series of n PCM samples in a buffer if required by the particular compression algorithm being used. There are various algorithms that may be employed for reducing the effective data rate of PCM sample streams, as known by those familiar with digital audio. Some algorithms require a buffer of samples, while others operate on a single sample at a time. Compressed audio buffer module 624 temporarily stores compressed digital audio in preparation for responding to requests from A/V stream control module 622 for compressed audio buffers.

External video camera 610 captures a video stream (for example, in the same environment as the external microphone 608). If the captured video is analog, the A/D conversion module 636 converts the series of analog frames of video into a series of digital video streams. It is noted that according to some embodiments the audio microphone 608 and the video camera 610 may be contained in the same device. Digitized frames of video are forwarded to the video pixel buffer 634. As is known in the video field, a video A/D conversion module may actually separate analog video into digitized frames with separated color planes (for example, YUV12). Video compression module 632 can employ at least one digital video compression algorithm to reduce the effective data rate of the stream of digital video frames. As is known in the video field, there are various algorithms for reducing the effective data rate of captured, digitized video. Compressed video buffer module 630 temporarily stores compressed digital video in preparation for responding to requests from A/V stream control module 622 for compressed video buffers.

Compressed audio is forwarded from A/V stream control module 622 to the compressed audio buffer module 638. Audio decompression is performed at module 640, and if the external audio speaker 612 is an analog device, the D/A conversion module 642 is inserted to convert the decompressed audio PCM to an analog waveform.

Compressed video is forwarded from A/V stream control module 622 to the compressed video buffer module 644. Video decompression module 646 decompresses video into individual video frames and forwards them to the video pixel buffer 648. As is known in the video field, the output of the video decompression algorithm may actually be a format that separates the color planes (for example, YUV12). If the video display is analog, a D/A conversion module 650 is needed to generate the appropriate analog video signal.

The A/V streaming control module 622 has two important functions of multiplexing compressed audio and video and de-multiplexing received A/V packets. A/V streaming control module 622 multiplexes compressed audio and video obtained from modules 624 and 630 into a packet stream with appropriate packet header information. Modules 624 and 630 stay filled with media by requesting further buffered audio and video from 626 and 632, respectively. A/V streaming control module 622 transmits the resulting packets over the network 604. As known in the digital video communications field, standard recommendations are available for the format of A/V packets and standard recommendations for transport protocol are optimized for A/V. RTP (Real-time Transport Protocol) is an example of a transport protocol employed in IP-based communication. A/V streaming control module 622 may additionally transmit A/V packets using a policy established to assure a continuous video experience on the receiving end, and to minimize packet loss on the network (for example, on a LAN and/or a WAN), due to, for example, sending redundant packets.

A/V streaming control module 622 also can de-multiplex A/V packets (received, for example, from the network 604) into individual buffers of compressed audio and video, and then forwards them to modules 638 and 644.

UPnP control point and local device control module 652 performs UPnP control-point functions over the network 604 such as locating and utilizing service actions on the HCS 602. The UPnP control point and local device control module 652 enables the DCA 606 to initiate outbound calls on the HCS 602. Module 652 additionally communicates information obtained from the HCS 602 via the UPnP control point to A/V stream control module 622 for starting A/V streams (for example, IP addresses). Module 652 also marshals user command input received from user input module 654 and routes it to the UPnP control point or to A/V stream control module 622. Module 652 also forwards content such as control menus to video display 614 via modules 648 and 650. User input module 654 receives user input from the external user input device 616 and forwards the user input to the UPnP control point and local device control module 652. According to some embodiments user input device 616 is a keyboard, and IR remote, and/or any other user input device.

UPnP device 656 is an optional UPnP device that is a network-discoverable (for example, LAN-discoverable) UPnP device. A DCA 606 that hosts such an optional UPnP device 656 may be discovered by other UPnP control points connected to the network 604. The UPnP device 656 may additionally include UPnP services that may be executed by control points. The UPnP services may be specifically designed to enable the DCA to be notified of and receive inbound calls from DCAs inside and/or outside of the home.

A DCA such as DCA 606 may be connected to an HCS such as HCS 602 in order to establish an audio and/or video conference. UPnP control point and local device control module 652 of the DCA 606 queries the home network 604 to obtain the IP address of the UPnP HCS 602 using known UPnP techniques. Using the same UPnP techniques, the DCA obtains the SOAP (“Simple Object Access Protocol”) service interface for the HCS 602. The UPnP control point and local device control module 652 employs a SOAP action to retrieve XML-standardized contact listings, for example. The XML listings may additionally have been cached and saved as a result of a prior call initiated by the DCA 606. The XML listings are converted into a displayable form and are processed by the video pixel buffer 648 for display to the user on video display 614. The contact listings chosen for display may be limited only to those that are a match for the audio format, video format, and transport protocol capabilities of the DCA 606. In this manner, users may only see contacts that are already ascertained by module 652 to be ‘connect-able’. The user uses the user input device 616 to scroll through the listings. Module 652 may retrieve more listings from the HCS 602 in order to update the display, if necessary.

The user selects a contact and UPnP control point and local device control module 652 executes a SOAP action on the HCS 602 to request a connection to a selected contact. The SOAP action contains all metadata associated with the selected contact sufficient for the HCS 602 to establish an audio and/or video conference (for example, over the Internet), as well as the IP address and port number associated with the A/V stream control module 622. The HCS 602 employs the metadata received from the DCA 606 to make the Internet call on behalf of the DCA 606. The HCS 602 may utilize typical SIP procedures for the external call and, in some cases, may be bound by a single IP communications service provider. The external party accepts the call and an A/V stream is established between the DCA 606 and the external party through the Internet gateway. The HCS 602 may be required to extract the A/V media received form the DCA 606 and embed it into the communications protocol used for communicating over the Internet. This may require reformatting IP packets and their payloads, and may also include conversion of A/V media formats.

According to some embodiments an alternative method may be used to connect a DCA (for example, DCA 606) to an HCS (for example, HCS 602) and establishing an audio and/or video conference. Optional UPnP device 656 provides UPnP services exposed over the network 604 (for example, a LAN) to the UPnP control point on the HCS. These UPnP devices and control points are utilized by the HCS 602 to push a graphical phone user interface for display by the DCA 606. As known in the field of remote user interface protocols a network-connected device may be enabled to forward a graphical image to a display device, and user activity is returned in the form of events. A user of the DCA 606 can navigate the phone user interface to initiate outbound calls. Additionally, the same mechanism can be used by the HCS 602 to push notifications of incoming calls to the DCA 606. Upon receipt, the user interfaces enable a DCA user to receive the inbound calls and being a videoconferencing session.

According to some embodiments a DCA achieves a very low cost for adding audio and video conferencing capabilities to a device (for example, a TV) by offloading telephony, certification to service provider, Internet connectivity, and/or archive for contact lists to the HCS.

According to some embodiments a DCA can advantageously allow current vendors of DMA appliances to add two-way communications functionality to their products by adding only minimal additional computational resources and media capture capability to the DMA base configuration. According to some embodiments consumers can benefit by obtaining the ability to perform two-way audio and/or video conferencing on one or more (or every) TV in their house, for example.

Although some embodiments have been described herein as being on a home network, on a LAN and/or on a WAN, using a personal computer, interfacing with a television set, operating only on audio and/or video, etc., according to some embodiments these particular implementations may not be required.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
identifying a request for an outside line for a telephony call by a requesting extension device coupled to a home network;
placing telephony calls via an Internet connection on behalf of the requesting extension device;
detecting inbound calls from the Internet connection; and
routing the inbound calls from the Internet connection to an appropriate extension device coupled to the home network.

2. The method of claim 1, further comprising registering extension devices coupled to the home network to receive incoming calls using Universal Plug and Play procedures.

3. The method of claim 1, wherein the request is identified using Universal Plug and Play procedures.

4. The method of claim 1, further comprising allowing an extension device coupled to the home network to view stored contact listings.

5. The method of claim 1, further comprising allowing an extension device coupled to the home network to access message archives.

6. The method of claim 6, wherein the message archives include voice messages and text messages.

7. The method of claim 1, wherein the routing of the inbound calls is performed in response to information relating to caller identification or to information relating to time of day.

8. The method of claim 1, wherein the routing of inbound calls includes routing inbound calls to a message archive.

9. A home communications server comprising:
a Universal Plug and Play interface to identify a request for an outside line for a telephony call by a requesting extension device coupled to a home network; and
an IP telephony signaling and control module to detect inbound calls from an Internet connection and to route the inbound calls to an appropriate extension device coupled to the home network, and to place calls via the Internet connection on behalf of the requesting extension devices coupled to the home network.

10. The server of claim 9, further comprising a message archive, wherein the IP telephony signaling and control module is to forward inbound calls to the message archive in response to user preferences.

11. The server of claim 9, wherein the Universal Plug and Play interface is to register extension devices coupled to the home network.

12. The server of claim 9, wherein the Universal Plug and Play interface receives information submitted by extension devices coupled to the home network including at least one of current IP address of the extension device, friendly device identification, and audio capability profile.

13. The server of claim 9, further comprising a contact listing database to provide contact information.

14. The server of claim 9, further comprising a server policy database to hold policies for routing calls to extension devices.

15. The server of claim 14, further comprising a message archive, wherein calls are routed to the message archive in response to the policies held in the server policy database.

16. An article comprising:
a computer readable medium having instructions thereon which when executed cause a computer to:
identify a request for an outside line for a telephony call by a requesting extension device coupled to a home network;
place telephony calls via an Internet connection on behalf of the requesting extension device;
detect inbound calls from the Internet connection; and
route the inbound calls from the Internet connection to an appropriate extension device coupled to the home network.

17. The article of claim 16, the computer readable medium having instructions thereon which when executed further cause a computer to register extension devices coupled to the home network to receive incoming calls using Universal Plug and Play procedures.

18. The article of claim 16, the computer readable medium having instructions thereon which when executed further cause a computer to: allow an extension device coupled to the home network to view stored contact listings.

19. The article of claim 16, the computer readable medium having instructions thereon which when executed further cause a computer to: allow an extension device coupled to the home network to access message archives.
